(19) United States
(12) Patent Application Publication
(10) Pub. No.: US 2008/0071816 A1
(43) Pub. Date: Mar. 20, 2008

(54) TRANSMISSION OF SERVER-BASED SYSTEM EVENTS TO WEB SERVICE CLIENTS

(75) Inventor: Steven D. Gray, Tualatin, OR (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: TURNRIVER LLC, Portland, OR (US)

(21) Appl. No.: 11/532,829

(22) Filed: Sep. 18, 2006

(51) Int. Cl. G06F 7/00

(52) U.S. Cl. 707/101

(57) ABSTRACT

Embodiments of the present invention provide methods and systems for transmission of server-based system events to web service clients. Other embodiments may be described and claimed.

### TECHNICAL FIELD

Embodiments of the present invention relate to the field of computer networks, and more particularly, to transmission of server-based system events to web service clients.

### BACKGROUND

Many new distributed software systems recently released or currently under development are built using a service-oriented architecture (SOA) with web services exposed between client and server over TCP/IP and the Hypertext Transfer Protocol (HTTP) and secure HTTPS. Using web services and HTTP(S) provides for numerous advantages over older, more proprietary client/server and distributed system solutions.

For simple applications, the unidirectional request/response Message Exchange Pattern (MEP) of HTTP is sufficient to implement a basic service-oriented application. However, there is a very large drawback to the request/response MEP of HTTP: because web service clients initiate requests into the server (and the converse is not true), events that occur outside the scope of the request cannot be easily broadcast to interested clients. Unless a server-side event occurs shortly before a client-initiated request, the client will always have an outdated view of the server's current state.

The fixed role of each partner in the MEP (i.e., client and server, requester and responder) is what leads to the difficulty in reversing the initiation of the flow of data. Some solutions to this problem involve installing web server software on every client machine, thus allowing the server to switch roles and initiate requests to each client machine (acting as a server in this case) when events need to be propagated out to multiple clients. However, requiring client computers to run and expose web services is not desirable.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 schematically illustrates an exemplary embodiment of a computer network that may be comprised of one or more clients, in accordance with various embodiments of the present invention;

FIG. 2 schematically illustrates an exemplary embodiment of a server that may be utilized that may be comprised of one or more clients, in accordance with various embodiments of the present invention; and

FIG. 3 is a flowchart illustrating transmission of server-based events to web service clients, in accordance with various embodiments of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and systems for transmission of server-based system events to web service clients.

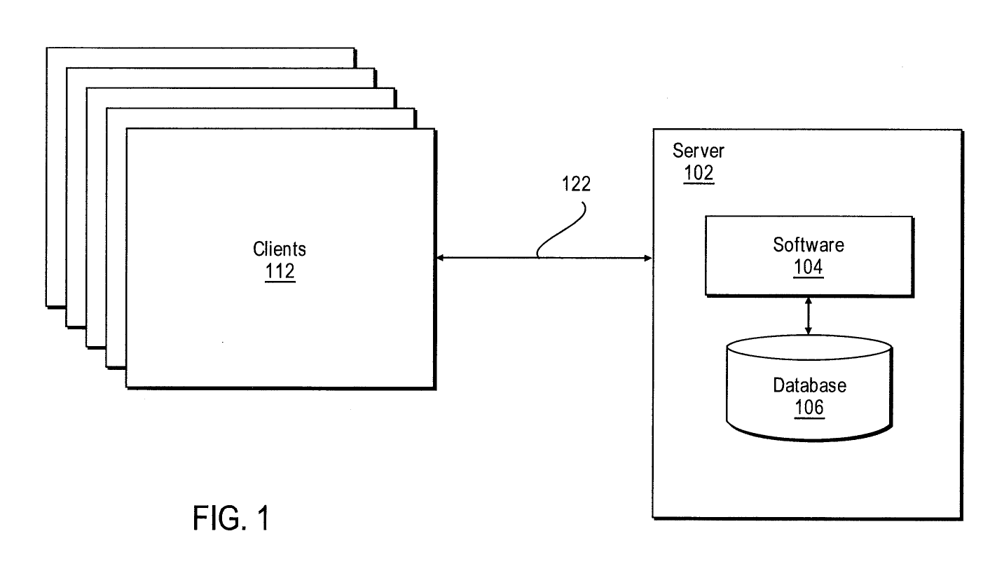

Referring now to FIG. 1, an overview of the present invention, in accordance with various embodiments, may be described. As illustrated, for the embodiments, server 102 is endowed with software 104, which is adapted with functions to provide information to clients. In particular, as will be described in more detail below, software 104 is adapted to provide clients 112 with updated information relating to one or more events.

For the various embodiments, server 102 may also be provided with a database 106 that may have data of the clients. In alternate embodiments, database 106 may be remotely disposed away from server 102.

In various embodiments, software 104 may present the information in the form of web pages. That is, server 102 may be further endowed with a web server and various communication interfaces, whereas client devices are endowed with a browser and corresponding communication devices.

In other embodiments, the information may be presented in other formats, e.g. as an attachment to electronic communications, and so forth.

For the various embodiments, clients 112 are communicatively coupled to server 102 via network connections 122 over a number of private and/or public networks, including, but not limited to, the Internet. The communications between clients 112 and server 102 may be conducted in accordance with one of a number of messaging protocols, including but are not limited to, e.g., the HTTP protocol (HTTP=Hypertext Transmission Protocol).

Except for software 104, database 106, server 102 and client devices 114 represent a broad range of such elements known in the art, or to be designed (as long as they are consistent with the teachings of the present invention). Accordingly, except for software 104, and an example of server 102, database 106, clients 112 and coupling 122 will not be further described.

While for ease of understanding, server 102 is “singularly” illustrated, in various embodiments, server 102 may be a single computing device, a cluster of tightly coupled computing devices, or networked computing devices.

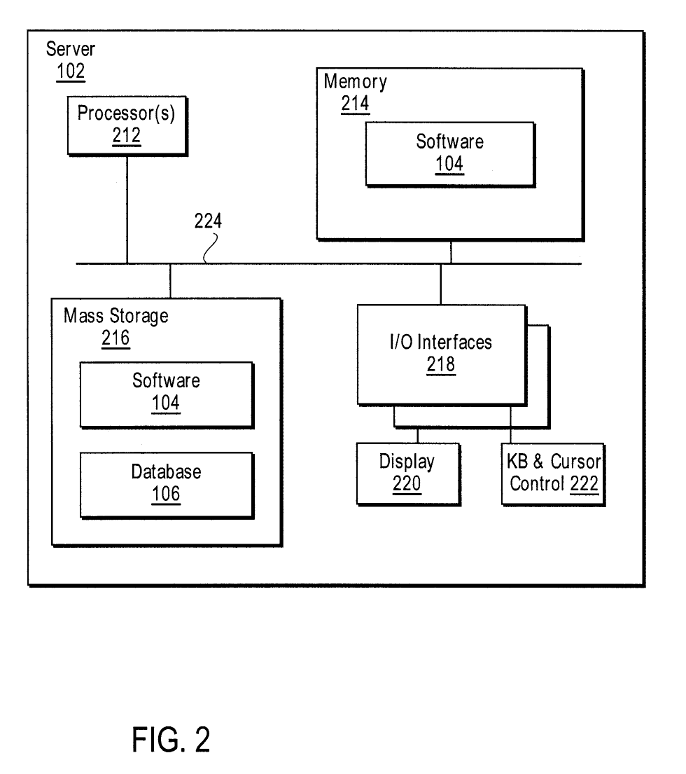

FIG. 2 illustrates an example implementation of server 102 of FIG. 1, in accordance with various embodiments of the present invention. As illustrated, server 102 includes digital computing processor 212, memory 214 coupled to each other via bus 224. Further, device 212 includes mass storage device 216, I/O interfaces 218, and a number of I/O devices coupled to each other and the earlier described elements as shown. Memory 214 and mass storage device 216 include in particular, a transient and a persistent copy of software 104, respectively. Mass storage device 216 further includes database 106. The I/O devices may include, in particular, display 220 and keyboard/cursor control 222.

In various embodiments, processor 212 may be any one of a number of microprocessors known in the art, or to be designed (as long as they are consistent with the teachings of the present invention), including but are not limited to, the processors available from Intel Corp., of Santa Clara, Calif.

Memory 214 may likewise be any one of a number of volatile storage known in the art or to be designed (as long as they are consistent with the teachings of the present invention), including but are not limited to, the volatile storage available from Kingston Technology of Fountain Valley, Calif. Mass storage device 216 may likewise be any one of a number of non-volatile storage known in the art or to be designed (as long as they are consistent with the teachings of the present invention), including but are not limited to, the non-volatile disk storage available from Seagate of Scotts Valley, Calif.

In various embodiments, I/O interfaces 218 include a communication interface for coupling server 102 to client devices 114. The communication interface may be a wire based or wireless interface, coupling server 102 to devices 114 via a wired/wireless local/wide area network. An example of a suitable wired network interface includes but is not limited to an Ethernet interface, and an example of a suitable wireless network interface includes but is not limited to an IEEE 802.11b (working group) network interface.

In embodiments of the present invention, an article of manufacture may be employed to implement one or more methods as disclosed herein. For example, in exemplary embodiments, an article of manufacture may comprise a storage medium and a plurality of programming instructions stored in the storage medium and adapted to implement one or more methods as disclosed herein in one or more servers and/or client devices.

Except for software 104 (described further herein), and the manner these elements are employed, each of these elements represents a broad range of the corresponding element known in the art or to be designed, consistent with the teachings of the present invention. The elements perform their conventional functions, i.e. processing, storage, reading, displaying, and so forth. While for ease of understanding, software component 104 is “singularly” illustrated, in various embodiments, software component may be a single or a plurality of processes, executed as a single thread or multiple threads, on a single or multiple processors.

In general, in accordance with various embodiments of the present invention, software 104 allows for a server to receive requests from one or more clients for updates with regard to information that may have been altered in response to some type of event. The event may have occurred at the server and may have been caused by a third-party or a client. Alternatively, the event may have occurred at a third-party or a client, with the third-party or client forwarding to the server an announcement of the occurrence of the event.

In accordance with various embodiments of the present invention, a client may forward a request to the server for an update with respect to information. Along with the request for the update, the client forwards an identification tag. The identification tag, in accordance with various embodiments, identifies the current version of the information that the client possesses. The server compares the identification tag with a version identifier in order to determine if the version that the client possesses is current. If the version of the information that the client possesses is not current, the server sends the client updated information, along with the updated identification tag. If the identification tag and the version identifier match, then the server suspends the request.

Once the client receives the updated information, the client updates the information and updates the corresponding identification tag with that which has been received from the server. In accordance with various embodiments of the present invention, the client then immediately sends another request to the server, wherein the request includes the updated identification tag. Once the server receives the new request, it once again compares the identification tag with the version identifier. Unless an event has occurred that has altered the information in the brief amount of time that has elapsed, the server suspends the request. However, if an event has occurred that has altered the information, i.e., the version identifier and the identification tag do not match, the server may once again forward the updated information and the updated identification tag to the client. The client once again updates the information and identification tag and immediately forwards another request to the server.

When an event occurs that alters information at the server, the server reactivates any requests from clients for updated information that had been suspended and forwards the updated information along with an updated identifier to the clients. The clients then update their corresponding information and corresponding identification tag and, in accordance with various embodiments of the present invention, forward new requests to the server.

Thus, in accordance with various embodiments of the present invention, rather than continually polling a server for updated information, the server maintains suspended requests for updated information, which the server handles and responds to upon the occurrence of an event that alters requested information. In accordance with various embodiments, clients forward requests to the server upon updating their information so that the server knows that the client essentially must be kept abreast of the most current information.

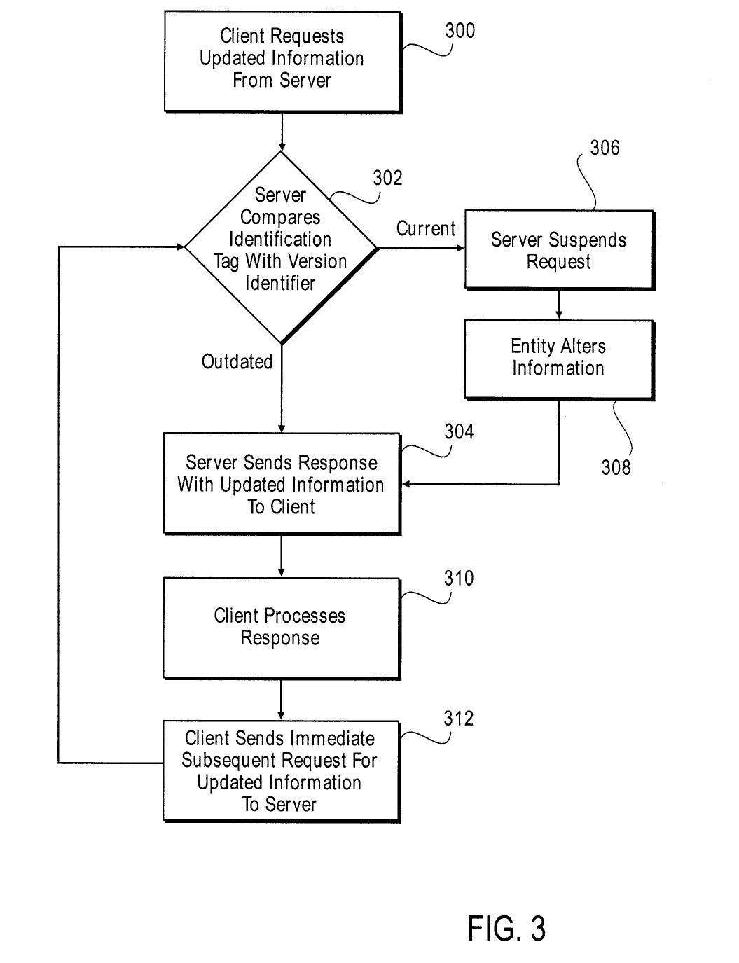

Thus, in particular, software 104 maintains the benefits of a service-oriented architecture, while providing for the effective publication of server-side events and data-change notifications to interested clients without wasting any network bandwidth and central processing unit (CPU) resources. As may be seen in FIG. 3, a client 112 informs a server 102 as part of a client-initiated request for the most recent update or version of some piece of information that the client possesses with respect to a given event or data element at 300. When a client's request comes into the server, the client's identification tag for the version it possesses is compared to the version identifier of the current version of the given event or data element for the information at the server at 302. Based on this comparison, if the client's version is outdated, the server returns an immediate response with the updated event information or data element, along with the corresponding new version identifier at 304. If the client's version matches the server's version, the client's connection to the server is suspended into a pool of waiting connections for clients at 306. This suspension keeps alive the networking connection between client and server, but consumes neither networking bandwidth nor CPU resources. When an entity alters the contents of a data element or raises an event for publication to clients at 308, the server restores all suspended client connections from the pool and completes the web transaction with a response containing the updated event information or data element, along with the corresponding new version identifier. When a response is received by the client, it is processed by the client at 310, and an immediate, subsequent request is sent to the server at 312. This request only returns with a response once a data element is updated or a server event occurs. The client sits in a loop, initiating new requests only when receiving server responses for as long as the client application is running.

Thus, server-side events occurring outside the scope of web client requests are effectively broadcast to all interested clients without wasting network bandwidth and CPU resources.

As an example, a web services stock ticker client application needs to display the latest trading price of stock XYZ. In accordance with various embodiments of the present invention, the client interacts with a web server in the following manner:

1. At startup, client application initiates an HTTP(S) POST (request) to the web server containing the user's desired stock ticker symbol (XYZ) and the currently known trading price identifier tag, which is 0 in an initial case.

2. In response to the HTTP(S) POST, the web server determines the current trading price of stock XYZ and the current version identifier number associated with that price, for example, version identifier=14. Note: any future changes to stock XYZ's price increases the version identifier number.

3. Because the client's identifier tag, 0, is less than the current server revision, 14, the web server returns an immediate, synchronous response to the web client containing the stock price's current price, along with the corresponding version identifier (14 in this example).

4. The web client parses the result and version identifier from the response, then immediately sends a subsequent HTTP(S) POST (request) to the web server, this time sending in identifier tag=14 as part of the request.

5. If the stock's price changed in the time it took the client to initiate a new request, an immediate response with the new data value and version identifier is returned. Often however, the client has the most current version of the particular stock's trading value because of the previous request/response exchange.

6. Assuming the stock's price is unchanged from the version known to the client, code within the web service suspends the client's web request into a pool of client connections, labeling the current request as one waiting for a change in stock XYZ's trading price.

7. Nothing occurs between the client and the server from that point until a change to XYZ's trading price occurs (freeing up the server to process other requests). No networking bandwidth or CPU resources are consumed for these suspended connections.

8. When a server-side database or other external system updates the stock's price, it also informs the web service of the updated price and new version identifier. Upon receipt of the updated stock price, the web server awakens all suspended HTTP(S) POST requests, completing them with a response containing the updated XYZ trading price along with the new version identifier.

9. Each web client parses the new trading price and version identifier number, and then initiates a new request to the server to await a new trading price update.

In accordance with various embodiments of the present invention, the version identifier and identification tag may be a number, and in some embodiments, may be an integer. In various alternate embodiments, a date-and-timestamp value may be used. In various other alternate embodiments, a universally unique identifier (UUID) or a globally unique identifier (GUID) may be used as the version identifier and identification tag. Additionally, in various other alternate embodiments a data element's value may be used with a hash function to create the version identifier and identification tag. When the data element's value changes, the version identifier will change based on the hash function. Those skilled in the art will understand that the above description of various version identifiers and identification tags are merely examples and that numerous other types of version identifiers and identification tags may be employed in accordance with various embodiments of the present invention.

Examples of applications for various embodiments of the present invention include financial applications where clients desire up-to-date financial data, such as a stock's ever-updating trading price as presented above, and news feeds or other subscription-based service applications, where client applications display news headlines or other content-change notifications (e.g., weather.com temperature updates) to users. Another example includes Email and instant messaging applications that could effectively connect to a SOA web server, thereby only receiving responses when either a new email or instant message arrives. A further example includes monitoring systems where an administrator or key decision-maker aggregates data and events from multiple, independent systems. An example of such a monitoring system is Executive Dashboard systems, where key financial data gets pushed out to client applications in near-real-time, allowing executives to track the “pulse” of their organizations.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method comprising:
receiving, by a server, a request from a client for a data element, the request including an identification tag indicating a version of the data element currently known by the client;
comparing, by the server, the identification tag with a version identifier for the data element indicating a current version of the data element at the server;
sending, by the server, an update message to the client if the identification tag is different from the version identifier, the update message comprising the current version of the data element and the version identifier;
suspending, by the server, the request for a data element, if the identification tag matches the version identifier, until the data element is altered by an event, at which time the server changes the version identifier and sends an update message comprising the current version of the data element and the version identifier to the client; and
receiving, by the server, another request for the data element from the client in response to the client receiving an update message from the server, the another request including an identification tag corresponding to the version identifier included in the received update message.

2. The method of claim 1, wherein the identification tag and the version identifier each comprise a numerical value and changing the version identifier comprises incrementing the version identifier.

3. The method of claim 2, wherein the numerical value is an integer value.

4. The method of claim 1, wherein the identification tag and the version identifier each comprise one of a date-and-time stamp value, a universally unique identifier or a globally unique identifier.

5. The method of claim 1, further comprising creating the version identifier for a data element with a hash function using a value of the data element.

6. The method of claim 1, wherein the receiving, by a server, a request from a client comprises receiving the request over the Internet.

7. The method of claim 1, wherein the sending, by the server, an update message to the client comprises sending the update message over the Internet.

8. The method of claim 1, wherein the event comprises one of a change in a game, a change in a financial instrument price, a change in a news headline, a change of status for a message account, and a change in an executive dashboard.

9. A system comprising:
a server configured to:
receive a request from a client for a data element, the request including an identification tag indicating a version of the data element currently at the client;
compare the identification tag with a version identifier for the data element indicating a current version of the data element at the server;
send an update message to the client if the identification tag is different from the version identifier, the update message comprising the current version of the data element and the version identifier;
suspend the request for a data element, if the identification tag matches the version identifier, until the data element is altered by an event, at which time the version identifier is changed by the server and an update message comprising the current version of the data element and the version identifier is sent to the client; and
receive another request for the data element from the client in response to the client receiving an update message from the server, the another request including an identification tag corresponding to the version identifier included in the received update message.

10. The system of claim 9, wherein the identification tag and the version identifier each comprise a numerical value and the server is configured to alter the version identifier by incrementing the version identifier and by resetting the version identifier.

11. The system of claim 9, wherein the numerical value is an integer value.

12. The system of claim 9, wherein the identification tag and the version identifier each comprise one of a date-and-time stamp value, a universally unique identifier or a globally unique identifier.

13. The system of claim 9, wherein the server is further configured to create the version identifier for a data element with a hash function using a value of the data element.

14. The system of claim 9, wherein the server and the client are communicatively coupled via the Internet.

15. The system of claim 9, wherein the event comprises one of a change in a game, a change in a financial instrument price, a change in a news headline, a change of status for a message account, and a change in an executive dashboard.

16. An article of manufacture comprising:
a storage medium; and
a plurality of instructions stored in the storage medium and designed to enable a server to perform a plurality of operations including:
receiving a request from a client for a data element, the request including an identification tag indicating a version of the data element currently known by the client;
comparing the identification tag with a version identifier for the data element indicating a current version of the data element at the server;
sending an update message to the client if the identification tag is different from the version identifier, the update message comprising the current version of the data element and the version identifier;
suspending the request for a data element, if the identification tag matches the version identifier, until the data element is altered by an event, at which time the server changes the version identifier and sends an update message comprising the current version of the data element and the version identifier to the client; and
receiving another request for the data element from the client in response to the client receiving an update message from the server, the another request including an identification tag corresponding to the version identifier included in the received update message.

17. The article of manufacture of claim 16, wherein the identification tag and the version identifier each comprise a numerical value and changing the version identifier comprises incrementing the version identifier.

18. The article of manufacture of claim 17, wherein the numerical value is an integer value.

19. The article of manufacture of claim 16, wherein the identification tag and the version identifier each comprise one of a date-and-time stamp value, a universally unique identifier or a globally unique identifier.

20. The article of manufacture of claim 16, wherein the plurality of instructions further include creating the version identifier for a data element with a hash function using a value of the data element

21. The article of manufacture of claim 16, wherein the receiving a request from a client comprises receiving the request over the Internet.

22. The article of manufacture of claim 16, wherein the sending an update message to the client comprises sending the update message over the Internet.

23. The article of manufacture of claim 16, wherein the event comprises one of a change in a game, a change in a financial instrument price, a change in a news headline, a change of status for a message account, and a change in an executive dashboard.
